(19) United States
(12) Patent Application Publication
(10) Pub. No.: US 2019/0207188 A1
(43) Pub. Date: Jul. 4, 2019

(54) ELECTRICAL AND THERMAL PROTECTION COATING AND ELECTROCHEMICAL BATTERY INCLUDING SAME

(71) Applicant: Unifrax I LLC, Tonawanda, NY (US)

(72) Inventors: Kenneth B. MILLER, Lockport, NY (US); Gary LEE, Lockport, NY (US); Mark BEAUHARNOIS, Buffalo, NY (US)

(21) Appl. No.: 16/235,580

(22) Filed: Dec. 28, 2018

Related U.S. Application Data
(60) Provisional application No. 62/613,400, filed on Jan. 3, 2018.

(51) Int. Cl. H01M 2/16; H01M 4/40; H01M 2/02; H01M 10/0525

(52) U.S. Cl. CPC H01M 2/166; H01M 4/405; H01M 10/0525; H01M 2/0282; H01M 2/029

(57) ABSTRACT

An inorganic platelet composition for use as electrical insulation, thermal insulation and fire protection for electrochemical cells such as lithium ion cells. The inorganic platelet composition may be applied directly to the exterior surfaces of the housings of one or more individual battery cells within a battery module and/or larger battery pack, and/or to the surfaces of the battery module or battery pack housing, and/or to structure surrounding the batteries, battery modules or battery packs that would benefit from electrical insulation and fire protection. The inorganic platelet composition can minimize or prevent thermal runaway events that may originate from one battery cell or within modules of battery cells from propagating to adjacent or nearby cells, modules, packs or other structures.

This application claims the benefit of the filing date under 35 U.S.C. § 119(e) from U.S. Provisional Patent Application Ser. No. 62/613,400, filed Jan. 3, 2018.

### TECHNICAL FIELD

The present disclosure relates to a thermal insulation and/or electrical insulation and/or fire protection composition for electrochemical battery cells, modules and packs, and electrochemical battery modules and packs including the composition.

Lithium ion batteries are widely used to provide power to electric or hybrid vehicles, (such as automobiles, buses, trucks, motorcycles, motorized bicycles, etc.) aircraft, marine craft, power tools, energy storage systems (such as uninterruptable power supplies, stationary storage systems, and/or for electric grid back-up applications), and portable electronic devices such as lap tops, notebooks, tablet computers, cellular telephones, smart telephones, digital cameras, digital camcorders, handheld gaming devices, MP3 players, PDAs, iPods, flashlights and like electronic devices.

A lithium ion battery includes an outer metal housing. Enclosed within the outer metal housing are a cathode (ie, positive electrode), an anode (ie, negative electrode) and a separator. In a typical cylindrical lithium ion battery, the cathode, anode and separator are provided in the form of a long spiral roll of thin sheets. The cathode, anode and separator sheets are submerged in a solvent that acts as an electrolyte. The separator separates the anode and cathode while permitting lithium ions to pass through it.

In a typical lithium ion cell the cathode may be made from lithium cobalt oxide (LiCoO₂), lithium iron phosphate (LiFePO₄), lithium titanium oxide (Li₂TiO₃), nickel manganese cobalt, nickel cobalt aluminum, or lithium manganese oxide (LiMn₂O₄). The anode may be made of carbon (such as graphite), or lithium titanium oxide (Li₄Ti₅O₁₂ (such as in aerogel form)). During the charging process, in certain embodiments, when the lithium ion cell is absorbing power, lithium ions move through the electrolyte from the cathode to the anode and attach to the carbon. During discharging process, in certain embodiments, when the lithium ion cell is discharging power, the lithium ions move back through the electrolyte from the carbon anode to the lithium cathode.

Lithium ion battery packs may be comprised of one to thousands of lithium ion cells. Large lithium ion batteries may comprise individual modules or cells that are organized in series or parallel. The lithium ion cell is the smallest unit a lithium ion battery can take. A module comprises several individual lithium ion cells that are electrically connected in series or parallel.

A lithium ion battery pack may be assembled by electrically connecting a plurality of lithium ion modules together in series or parallel.

Lithium ion cells are susceptible to “thermal runaway.” The term “thermal runaway” refers to a rapid uncontrolled increase in temperature. The electrolyte contained within the lithium ion cell may be highly flammable. In the event that the cell or module experiences a “thermal runaway” condition, the electrolyte contained within the cells may ignite causing an explosion and fire.

### SUMMARY

Provided is an electrical insulation and fire protection composition comprising inorganic platelets, a high temperature resistant binder, a viscosity modifier, and liquid.

Also provided is an electrical insulation and fire protection coating composition comprising inorganic platelets, a high temperature resistant binder, a viscosity modifier, and liquid.

Additionally provided is an electrochemical cell comprising an outer housing and an electrical insulation and fire protection composition applied to the exterior surface of the outer housing of the electrochemical cell, wherein the electrical insulation and fire protection composition comprises inorganic platelets, a high temperature resistant binder, a viscosity modifier and liquid.

Additionally provided is an electrochemical cell comprising an outer housing and an electrical insulation and fire protection coating composition applied to the exterior surface of the outer housing of the electrochemical cell, wherein the electrical insulation and fire protection coating composition comprises inorganic platelets, a high temperature resistant binder, a viscosity modifier and liquid.

Further provided is an electrochemical battery module comprising a plurality of individual electrochemical battery cells electrically connected together, each of said individual electrochemical battery cells having an outer housing and said electrochemical module comprising interstitial spaces between the outer housings of said individual electrochemical battery cells, and an electrical insulation and fire protection coating composition comprising inorganic platelets, a high temperature resistant binder, a viscosity modifier and liquid applied to at least a portion of the surface of said outer housings of said electrochemical battery cells and/or located within at least a portion of said interstitial spaces between said individual electrochemical battery cells of said electrochemical battery module.

Further provided is an electrochemical battery pack comprising a plurality of individual electrochemical battery cells electrically connected together and having interstitial spaces between the individual electrochemical battery cells, and an electrical insulation and fire protection coating composition comprising inorganic platelets, a high temperature resistant binder, a viscosity modifier and liquid applied to at least a portion of the exterior surfaces of said outer housings of said electrochemical battery cells and/or located within at least a portion of said interstitial spaces between said individual electrochemical battery cells of said electrochemical battery pack.

Further provided is a method for minimizing the propagation of thermal runaway within an electrochemical battery pack comprising a plurality of individual electrochemical battery cells electrically connected together and having interstitial spaces between the individual electrochemical battery cells, the method comprising applying an electrical insulation and fire protection coating composition comprising inorganic platelets, a high temperature resistant binder, a viscosity modifier and liquid to at least a portion of the exterior surfaces of said outer housings of said electrochemical battery cells and/or locating said coating composition within at least a portion of said interstitial spaces between said individual electrochemical battery cells of said electrochemical battery pack.

Further provided is an electric vehicle or hybrid electric vehicle comprising a structural frame, a passenger cabin, an electric drive motor, a motor controller, braking system, and electrochemical battery pack, said electrochemical battery pack comprising a plurality of individual battery cells electrically connected together and having interstitial spaces between the individual battery cells, and an electrical insulation and fire protection coating composition comprising inorganic platelets, a high temperature resistant binder, a viscosity modifier and liquid applied to at least a portion of the exterior surfaces of said outer housings of said electrochemical battery cells and/or located within at least a portion of said interstitial spaces between said individual electrochemical battery cells of said electrochemical battery pack.

### DETAILED DESCRIPTION

Provided is a composition to mitigate the propagation of thermal runaway in an electrochemical battery module or electrochemical battery pack that is comprised of a plurality of individual electrochemical battery cells. The composition mitigates the effects of one or more individual battery cells undergoing a thermal runaway event, thereby preventing the propagation of the thermal runaway event to neighboring cells within a battery module or battery pack. The composition is based on inorganic refractory platelets.

A battery pack is also provided. The battery pack includes a plurality of electrochemical battery cells and the electrical and/or fire protective barrier based on an inorganic platelet composition. The composition is used to isolate individual cells or divide individual cells within the battery pack. The composition separates the battery cells into groups or into individual cells to prevent a thermal runaway event initiated in an individual cell or in a group of cells from propagating to the cells within a neighboring group of cells.

The electrical insulation and fire protection coating composition is included in at least one of the following regions of the battery pack: (i) the composition may be applied to at least a portion of the exterior surface of the individual electrochemical battery cells contained within a larger bank of electrically connected electrochemical battery cells such as a battery module or battery pack, (ii) the composition may be applied to at least a portion of the interior surface of the housing of the electrochemical battery pack; (iii) the composition may be applied to at least a portion of the exterior surface of the housing of the battery pack; and/or (iv) the composition may be located within at least a portion of the interstitial spaces between a plurality of electrochemical battery cells within a larger battery module or battery pack.

As used throughout the present specification, the terms “battery”, “cell”, and “battery cell” may be used interchangeably and may refer to any of a variety of different cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration.

As used throughout the present specification, the term “battery pack” refers to multiple individual battery cells contained within a suitable housing, the individual battery cells electrically interconnected to achieve the desired voltage and capacity for a particular application.

As used throughout the present specification, the term “electric vehicle” may refer to an all-electric vehicle, also referred to as an EV, a plug-in hybrid vehicle, also referred to as a PHEV, or a hybrid vehicle, also referred to as a HEV, where a hybrid vehicle refers to a vehicle utilizing multiple propulsion sources one of which is an electric drive system.

Recitation of ranges of values herein are merely intended to serve as a shorthand method of referring individually to each separate value falling within the range, unless otherwise indicated herein, and each separate value is incorporated into the specification as if it were individually recited herein. It should be understood that when an amount or concentration range is described in the present disclosure, it is intended that any and every amount or concentration within the range, including the end points, is to be considered as having been stated. For example, “a range of from 1 to 10” is to be read as indicating each and every possible number along the continuum between 1 and 10. It is to be understood that the inventors appreciate and understand that any and all data points within the range are to be considered to have been specified, and that the inventors have possession of the entire range and all points within the range.

In the present disclosure, the term “about” used in connection with a quantity is inclusive of the stated value and has the meaning dictated by the context (for example, it includes at least the degree of error associated with the measurement of the particular quantity). One of skill in the art would understand the term “about” is used herein to mean that an amount of “about” a recited percentage (%) produces the desired degree of effectiveness in the compositions and methods of the present disclosure. One of skill in the art would further understand that the metes and bounds of “about” with respect to the quantity of any component in an embodiment can be determined by varying the quantity of one or more components, determining the effectiveness of the mixture for each concentration, and determining the range of concentrations that produce mixtures with the desired degree of effectiveness in accordance with the present disclosure. The term “about” is further used to reflect the possibility that a mixture may contain trace components of other materials that do not alter the effectiveness or safety of the mixture.

In the present disclosure, the term “substantially” refers to a degree of deviation that is sufficiently small so as to not measurably detract from the identified property or circumstance. The exact degree of deviation allowable may in some cases depend on the specific context.

The compositional weight percentages disclosed herein are based on the total weight of the composition. It will be understood to one of ordinary skill in the art that the total weight percent of the composition cannot exceed 100%. For example, a person of ordinary skill in the art would easily recognize and understand that a composition comprising about 5 to about 70 weight percent inorganic platelets, about 2 to about 60 weight percent binder, from about 5 to about 10 weight percent of rheology modifier, and from about 40 to about weight percent 90 liquid based on the total weight of the composition will not exceed 100%. A person of ordinary skill in the art would understand that the amount of inorganic platelets, binder, rheology modifier and liquid will be adjusted to include the desired amount of these components without exceeding 100% by weight of the composition.

The use of the terms “a” and “an” and “the” and similar referents in the context of describing the present disclosure are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise indicated. The use of any and all examples, or exemplary language (e.g., “such as”) provided herein, is intended merely to better illuminate the present disclosure and does not pose a limitation on the scope of the invention unless otherwise claimed. All methods described herein can be performed in any suitable order unless otherwise indicated herein or otherwise clearly contradicted by context.

The inorganic platelets of the electrical insulation and fire protection coating composition may be selected from vermiculite platelets, mica platelets, clay platelets, talc platelets and combinations of one or more different types of these inorganic platelets.

According to certain embodiments, the inorganic platelets comprise vermiculite platelets. According to certain embodiments, the inorganic platelets comprise mica platelets. According to certain embodiments, the inorganic platelets comprise clay platelets. According to certain embodiments, the inorganic platelets comprise a blend of vermiculite and mica platelets. According to certain embodiments, the inorganic platelets comprise a blend of vermiculite and clay platelets. According to certain embodiments, the inorganic platelets comprise a blend of vermiculite and talc platelets.

Formulated and unformulated dispersions of vermiculite platelets may be commercially obtained from Dicalite Management, Inc. (Bala Cynwyd, Pa., USA) under the tradename MICROLITE. Commercially available unformulated MICROLITE dispersions include 903, 923, 963 and HTS. Commercially available formulated MICROLITE dispersions include HTX-XE, HTS-XE20 and HTS-SE.

Without limitation, and only by way of illustration, suitable mica that may be used as the inorganic platelets in the electrical insulation and fire protection coating composition includes muscovite, phlogopite, biotite, lepidolite, glauconite, paragonite and zinnwaldite, and synthetic micas such as fluorophlogopite. Suitable mica platelets are commercially available from Eckhart America Corporation under the trade designations C001 and E0001, from BASF Corporation under the trade designation Magnapearl, and from Brenntag Specialties Inc. (South Plainfield, N.J., USA) under the trade designations SG-70, SG-75 and SG-90. The mica platelets have a median particle size from about 10 to about 50 microns, or about 15 to about 35 microns, or about 25 to about 35 microns, or about 15 to about 25 microns, or about 20 to about 30 microns.

According to certain embodiments, the inorganic platelet composition may comprise coated platelets. Without limitation, and only by way of illustration, the inorganic platelets may be at least partially coated with a coating selected from, such as, for example, titanium dioxide, iron oxide, chromium oxide, tin oxide, silicon oxide, cobalt oxide, antimony oxide and combinations thereof. According to certain embodiments, the inorganic platelets comprise coated vermiculite platelets. According to certain embodiments, the inorganic platelets comprise coated mica platelets. According to certain embodiments, the inorganic platelets comprise coated clay platelets. According to certain embodiments, the inorganic platelets comprise coated talc platelets. According to certain embodiments, the inorganic platelets comprise a blend of coated vermiculite and coated mica platelets.

The inorganic platelets that may be used to prepare the inorganic coating composition may be exfoliated. Exfoliated means that the platelets are chemically and/or thermally expanded. According to other illustrative embodiments, the platelets may be exfoliated and/or defoliated. Defoliated means that the exfoliated platelets are further processed in order to reduce the platelets to substantially a desired platelet form.

Without limitation, and only by way of illustration, suitable platelet clay material that may be used as the inorganic platelets may include, without limitation, ball clay, bentonite, smectite, hectorite, kaolinite, montmorillonite, saponite, sepiolite, sauconite, or combinations thereof.

While any size inorganic platelet material may be used to prepare the inorganic platelet composition, inorganic platelets with larger relative diameters and high diameter to thickness aspect ratios may be desirable due to their gas impermeability, as well as other properties such as flexibility and processability. An inorganic platelet is a thin plate-like inorganic mineral having a width that is greater than its thickness. In certain illustrative embodiments, the inorganic platelets may have a diameter of from about 20 μm to about 300 μm. In certain embodiments, the inorganic platelets may have a diameter of from about 40 μm to about 200 μm. The geometry of the inorganic platelets is defined by an aspect ratio (ie, width:thickness). In certain embodiments, the inorganic platelets may have an aspect ratio of from about 50:1 to about 2000:1. In certain embodiments, the inorganic platelets may have an aspect ratio of from about 50:1 to about 1000:1. In further embodiments, the inorganic platelets may have an aspect ratio of from about 200:1 to about 800:1.

According to certain illustrative embodiments, the inorganic refractory composition comprises from about 5 to about 70 weight percent inorganic platelets, from about 2 to about 60 weight percent binder, from about 5 to about 10 weight percent of rheology modifier, and from about 40 to about weight percent 90 liquid, based on the total weight of the composition.

According to certain illustrative embodiments, the inorganic refractory composition comprises from about 5 to about 10 weight percent inorganic platelets, from about 10 to about 20 weight percent binder, from about 1 to about 2 weight percent of rheology modifier, and from about 70 to about 80 weight percent liquid, based on the total weight of the composition.

According to certain illustrative embodiments, the inorganic refractory composition comprises from about 7 to about 9 weight percent inorganic platelets, from about 15 to about 17 weight percent binder, from about 1 to about 1.5 weight percent of rheology modifier, and from about 72 to about 75 weight percent liquid, based on the total weight of the composition.

According to certain illustrative embodiments, the inorganic refractory platelet composition comprises from about 5 to about 70 weight percent inorganic platelets, from about 2 to about 60 weight percent binder, from about 5 to about 10 weight percent of rheology modifier, about 5 to about 40 of a functional additive other than platelets, and from about 40 to about 90 weight percent liquid, based on the total weight of the composition.

According to certain illustrative embodiments, the inorganic refractory composition comprises from about 5 to about 10 weight percent inorganic platelets, from about 10 to about 20 weight percent binder, from about 1 to about 2 weight percent of rheology modifier, about 5 to about 40 of a functional additive other than platelets, and from about 70 to 80 to about weight percent liquid, based on the total weight of the composition.

According to certain illustrative embodiments, the inorganic refractory composition comprises from about 7 to about 9 weight percent inorganic platelets, from about 15 to about 17 weight percent binder, from about 1 to about 2 weight percent of rheology modifier, about 15 to about 17 of a functional additive other than platelets, and from about 72 to 75 to about weight percent liquid, based on the total weight of the composition.

According to certain illustrative embodiments, the inorganic refractory composition comprises from about 6 to about 9 weight percent inorganic platelets, from about 14 to about 16 weight percent binder, from about 1 to about 2 weight percent of rheology modifier, and from about 74 to 78 to about weight percent liquid, based on the total weight of the composition.

According to certain illustrative embodiments, the inorganic refractory composition comprises from about 11 to about 14 weight percent inorganic platelets, from about 22 to about 27 weight percent binder, from about 0.5 to about 2 weight percent of rheology modifier, and from about 60 to 64 to about weight percent liquid, based on the total weight of the composition.

The inorganic composition includes a high temperature resistant organic and/or inorganic binder in addition to the inorganic platelets to adhere or bind the inorganic platelets together within a coated film, layer or sheet of inorganic platelets. The binder may comprise an organic binder, or a blend of more than one organic binder. The binder may be an inorganic binder, or a blend of more than one inorganic binder. The binder may include a blend of an organic binder and an inorganic binder. The binder may include a blend of more than one type of organic binder and one type of inorganic binder. The binder may include one type of organic binder and more than one type of inorganic binder. The binder may include a blend of more than one type of organic binder and more than one type of inorganic binder.

The organic binder may comprise a single type of organic binder or a blend of more than one type of organic binder. The organic binder(s) may be provided as a solid, a liquid, a solution, a dispersion, a latex, or similar form. Examples of suitable organic binders that may be included in the composition include, but are not limited to, acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, organosilicones, organosilanes, unsaturated polyesters, epoxy resins, polyvinyl esters such as polyvinylacetate or polyvinylbutyrate latexes and the like. According to certain embodiments, the organic binder included in the composition comprises an organosilicone binder. According to certain embodiments, the organosilicone binder comprises an organopolysiloxane binder. According to certain embodiments, the organopolysiloxane binder comprises a diorganopolysiloxane binder. The organopolysiloxane binder may contain alkyl, alkoxy and aryl functional groups. Without limitation, a suitable organopolysiloxane resin binder is commercially available from Momentive Performance Materials (Waterford, N.Y., USA) under the trade designation SILRES M97E, Aremco Products, Inc. (Valley Cottage, N.Y., USA) under the trademark CERAMABIND 880, and from Dow Chemical (Midland, Mich., USA) under the trade designations DOW 75 and DOW 84. Suitable acrylic emulsions are commercially available from Lubrizol Corporation (Wickliffe, Ohio, USA).

The inorganic binder may comprise a single type of inorganic binder or a blend of more than one type of inorganic binder. The inorganic binder may be an inorganic particulate. Without limitation, suitable inorganic particulate binders that may be included in inorganic platelet composition include colloidal alumina, colloidal silica, colloidal zirconia, and combinations thereof. Commercially available formulations of colloidal inorganic oxide may be utilized, by way of illustration and not limitation, NALCO colloidal silica comprising 40% solids, available from Nalco Company (Naperville, Ill., USA). However, other grades of colloidal inorganic oxide may also be used, such as 30% solids content or less, or alternatively greater than 40% solids content.

The inorganic platelet composition may include mica platelets and an inorganic binder. The inorganic binder may comprise a single type of inorganic binder or a blend of more than one type of inorganic binder. Without limitation, suitable inorganic binders that may be included in inorganic platelet composition may include colloidal alumina, colloidal silica, colloidal zirconia, and mixtures thereof.

The inorganic platelet composition may include a blend of mica and vermiculite platelets and an inorganic binder. The inorganic binder may comprise a single type of inorganic binder or a blend of more than one type of inorganic binder. Without limitation, suitable inorganic binders that may be included in inorganic platelet composition include colloidal alumina, colloidal silica, colloidal zirconia, and mixtures thereof.

The inorganic platelet composition may include mica platelets and at least one organic binder. The inorganic platelet composition may include vermiculite platelets and at least one organic binder. The inorganic platelet composition may include a blend of mica and vermiculite platelets and at least one organic binder.

The inorganic platelet composition also includes a rheology modifier. According to certain embodiments, the rheology modifier comprises a thickening agent (i.e., a thickener). The thickening agent may be included in an amount sufficient to improve the suspension of the inorganic platelets within the composition. The addition of the thickening agent to the composition may prevent the inorganic platelets from settling and hardening prematurely. The addition of the thickening agent also affects the viscosity of the coating composition so that by controlling the amount of water and thickening agent in the mixture, the mixture may have a viscosity suitable for trowelling, spraying, dipping, molding, gunning and/or brushing applications Without limitation, and only by way of illustration, suitable thickening agents for the composition include acrylates, polyvinyl alcohol, clays such as attapulgite clay, bentonite clay and smectite clay, cellulose polymers including substituted celluloses such as methyl cellulose, carboxymethyl cellulose, hydroxymethyl cellulose, hydroxyethyl cellulose, hydroxypropyl cellulose, guar gum, xanthan gum, acacia gum, locust bean gum, agar, pectin, gelatin, carrageenan, and alginates such as sodium alginate, potassium alginate, ammonium alginate, and calcium alginate.

Without limitation, suitable thickening agents that may be used in the refractory coating material include bentonite clay and/or magnesium aluminum silicate, such as Veegum T (sold by the R. T. Vanderbilt Company, Inc.). Veegum T acts as a rheology modifier to maintain a suitable rheology of the inorganic platelet composition and prevents decantation of any of the components in the composition. The inorganic platelet composition may comprise about 0.1 to 3 weight percent magnesium aluminum silicate, such as Veegum T.

According to certain illustrative embodiments, the composition may be applied to an underlying support and provided as a composite material. According to these embodiments, at least one continuous layer of the composition may be applied to a surface of the underlying support to create a composite comprising the underlying support and at least one layer of the inorganic platelet composition carried on at least a portion of the surface of the underlying support. For illustrative embodiments where the inorganic platelets are carried on a support layer, the inorganic platelets may be added to the support layer in an amount of about 25 gsm to about 500 gsm. According to certain embodiments, the inorganic platelets may be added to the support layer in an amount of about 30 gsm to about 400 gsm. According to other embodiments, the inorganic platelets may be added to the support layer in an amount of about 40 gsm to about 300 gsm.

The one or more support layers of the thermal insulation barrier may comprise a polymer film, a paper, a cloth, a non-woven fabric, a woven fabric or combinations thereof. According to certain embodiments, the inorganic platelet composition may be adhered to the underlying support layer through a suitable amount of adhesive positioned between the support layer and inorganic platelet layer. In some embodiments, the composite may comprise, in order, an underlying support layer, an adhesive layer on a surface of the support layer and a layer of the inorganic platelet composition on the adhesive layer.

The barrier may comprise a multiple layer composite comprising a support layer, an adhesive layer applied to a major surface of the support layer, and an inorganic platelet composition/layer applied to the adhesive layer. The inorganic platelet layer may be supplied as a fluid coating composition that is coated onto a major surface of the adhesive layer. Alternatively, the inorganic platelet layer may be first formed into a film, paper, or sheet, and then the sheet of inorganic platelets joined to the support layer with the adhesive layer being positioned between these two layers to bond the inorganic platelet sheet to the support layer. The multiple layer composite may further include a reinforcing layer. According to certain embodiments, the reinforcing layer may comprise an open weave reinforcing scrim. The reinforcing scrim may be placed adjacent the major surface of the support layer, may be embedded into the adhesive layer, may be embedded into the inorganic platelet layer, or any combination thereof.

According to certain illustrative embodiments, the one or more support layer(s) comprises a polymer film. The polymer film may be selected from polyester, polyimide, polyetherketone, polyetheretherketone, polyvinylfluoride, polyamide, polytetrafluoroethylene, polyaryl sulfone, polyester amide, polyester imide, polyethersulfone, polyphenylene sulfide, ethylene chlorotrifluoroethylene films and combinations thereof. According to certain embodiments, the polymer film comprises a polyetheretherketone film.

According to other illustrative embodiments, the one or more support layer(s) comprises a fiber paper. The paper comprising the support layer may comprise an inorganic fiber paper, such as a paper containing inorganic fibers and binder. The inorganic fibers may be selected from high alumina polycrystalline fibers, mullite fibers, ceramic fibers, glass fibers, biosoluble fibers, quartz fibers, silica fibers and combinations thereof. According to certain embodiments, heat resistant inorganic fibers may be included in the inorganic platelet composition.

Any heat resistant inorganic fibers may be used to prepare the support paper so long as the inorganic fibers can withstand the forming process and can provide the minimum fire protective properties required by the application. Without limitation, and only by way of illustration, suitable inorganic fibers that may be used to prepare the fire retardant composite include high alumina polycrystalline wool fibers, refractory ceramic fibers such as alumina-silica fibers, alumina-magnesia-silica fibers, kaolin fibers, alkaline earth silicate fibers such as calcia-magnesia-silica fibers and magnesia-silica fibers, S-glass fibers, S2-glass fibers, E-glass fibers, quartz fibers, silica fibers and combinations of one or more of these types of inorganic fibers.

According to certain embodiments, heat resistant inorganic fibers are used to prepare the paper layer for the inorganic platelets. Without limitation, and only by way of illustration, suitable refractory ceramic fibers include alumina fibers, alumina-silica fibers, alumina-zirconia-silica fibers, zirconia-silica fibers, zirconia fibers and similar refractory ceramic fibers. A suitable alumina-silica refractory ceramic fiber is commercially available from Unifrax I LLC (Tonawanda, N.Y., USA) under the registered trademark FIBERFRAX. The FIBERFRAX refractory ceramic fibers comprise the fiberization product of about 45 to about 75 weight percent alumina and about 25 to about 55 weight percent silica. The FIBERFRAX refractory ceramic fibers are able to withstand operating temperatures up to about 1540° C. and a melting point up to about 1870° C. The FIBERFRAX fibers are easily formed into high temperature resistant sheets and papers.

According to certain embodiments, the alumina-silica fiber may comprise from about 40 weight percent to about 60 weight percent Al₂O₃ and about 60 weight percent to about 40 weight percent SiO₂. According to other illustrative embodiments, the alumina-silica fiber may comprise about 50 weight percent Al₂O₃ and about 50 weight percent SiO₂.

The alumina-silica-magnesia glass fiber may comprise from about 64 weight percent to about 66 weight percent SiO₂, from about 24 weight percent to about 25 weight percent Al₂O₃, and from about 9 weight percent to about 10 weight percent MgO.

The E-glass fiber typically comprises from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weigh percent Al₂O₃, 7 weight percent B₂O₃, 3 weight percent MgO, 19 weight percent CaO and traces of the above mentioned materials.

Without limitation, suitable examples of alkaline earth silicate fibers that can be used to prepare the fiber paper support layer for the inorganic platelets include those fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,075, 5,821,183, and 5,811,360, which are incorporated herein by reference.

According to certain embodiments, the alkaline earth silicate fibers may comprise the fiberization product of a mixture of oxides of magnesia and silica. These fibers are commonly referred to as magnesium-silicate fibers. The magnesium-silicate fibers generally comprise the fiberization product of about 60 to about 90 weight percent silica, from greater than 0 to about 35 weight percent magnesia and 5 weight percent or less impurities. According to certain embodiments, the magnesium-silicate fibers comprise the fiberization product of about 65 to about 86 weight percent silica, about 14 to about 35 weight percent magnesia and 5 weight percent or less impurities. According to other embodiments, the magnesium-silicate fibers comprise the fiberization product of about 70 to about 86 weight percent silica, about 14 to about 30 weight percent magnesia, and 5 weight percent or less impurities. A suitable magnesium-silicate fiber is commercially available from Unifrax I LLC (Tonawanda, N.Y., USA) under the registered trademark ISOFRAX. Commercially available ISOFRAX fibers generally comprise the fiberization product of about 70 to about 80 weight percent silica, about 18 to about 27 weight percent magnesia and 4 weight percent or less impurities.

According to certain embodiments, the alkaline earth silicate fibers may comprise the fiberization product of a mixture of oxides of calcium, magnesium and silica. These fibers are commonly referred to as calcia-magnesia-silica fibers. According to certain embodiments, the calcia-magnesia-silica fibers comprise the fiberization product of about 45 to about 90 weight percent silica, from greater than 0 to about 45 weight percent calcia, from greater than 0 to about 35 weight percent magnesia, and 10 weight percent or less impurities. Useful calcia-magnesia-silica fibers are commercially available from Unifrax I LLC (Tonawanda, N.Y., USA) under the registered trademark INSULFRAX. INSULFRAX fibers generally comprise the fiberization product of about 61 to about 67 weight percent silica, from about 27 to about 33 weight percent calcia, and from about 2 to about 7 weight percent magnesia. Other suitable calcia-magnesia-silica fibers are commercially available from Thermal Ceramics (Augusta, Ga., USA) under the trade designations SUPERWOOL 607, SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia and trace amounts of magnesia, alumina and iron oxide.

Suitable silica fibers used in the production of the fiber paper support layer for inorganic platelets include those leached glass fibers available from BelChem Fiber Materials GmbH, Germany, under the trademarks BELCOTEX, from Hitco Carbon Composites, Inc. of Gardena Calif., under the registered trademark REFRASIL, and from Polotsk-Steklovolokno, Republic of Belarus, under the designation PS-23(R).

The BELCOTEX fibers are standard type, staple fiber pre-yarns. These fibers have an average fineness of about 550 tex and are generally made from silicic acid modified by alumina. The BELCOTEX fibers are amorphous and generally contain about 94.5 silica, about 4.5 percent alumina, less than 0.5 percent sodium oxide, and less than 0.5 percent of other components. These fibers have an average fiber diameter of about 9 microns and a melting point in the range of 1500° to 1550° C. These fibers are heat resistant to temperatures of up to 1100° C., and are typically shot free and binder free.

The REFRASIL fibers, like the BELCOTEX fibers, are amorphous leached glass fibers high in silica content for providing thermal insulation for applications in the 1000° to 1100° C. temperature range. These fibers are between about 6 and about 13 microns in diameter, and have a melting point of about 1700° C. The fibers, after leaching, typically have a silica content of about 95 percent by weight. Alumina may be present in an amount of about 4 percent by weight with other components being present in an amount of 1 percent or less.

The PS-23 (R) fibers from Polotsk-Steklovolokno are amorphous glass fibers high in silica content and are suitable for thermal insulation for applications requiring resistance to at least about 1000° C. These fibers have a fiber length in the range of about 5 to about 20 mm and a fiber diameter of about 9 microns. These fibers, like the REFRASIL fibers, have a melting point of about 1700° C.

The binder that may be included in the inorganic fiber paper may comprise an organic binder selected from acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, unsaturated polyesters, epoxy resins, polyvinyl esters and combinations thereof. According to other embodiments, the binder included in the inorganic fiber paper may comprise an inorganic binder. The inorganic binder may be selected from colloidal alumina, colloidal silica, colloidal zirconia and combinations thereof. The binder may include a blend of organic binder and inorganic binder. The binder may include a blend of more than one type of organic binder and one type of inorganic binder. The binder may include one type of organic binder and more than one type of inorganic binder. The binder may include a blend of more than one type of organic binder and more than one type of inorganic binder.

The one or more support layer(s) may comprise a woven fabric. The fibers of the woven fabric may comprise inorganic fibers, organic fibers, or a combination of inorganic and organic fibers. The inorganic fibers may be selected from carbon fibers and glass fibers. The organic fibers may be selected from polyolefin fibers, polyester fibers, polyamide fibers, aramid fibers and combinations thereof. According to other embodiments, the woven fabric is coated or impregnated with a coating composition.

In certain embodiments, the inorganic platelet composition/layer is directly or indirectly coated onto the support layer, applied to the support layer and permitted to impregnate or saturate into the thickness of the support layer, or impregnated into and coated onto the support layer. By indirectly coating, it is meant that the inorganic platelet layer may be coated onto a carrier layer, and the carrier layer engaged with the support layer with the inorganic layer disposed between the carrier layer and the support layer. The carrier layer can then be removed leaving a multiple layer composite comprising the inorganic platelet layer on the support layer.

In certain embodiments, a method of utilizing the inorganic platelet composition comprises coating the composition onto a surface or substrate, such as at least a portion of the exterior surface of the individual electrochemical battery cells, (ii) at least a portion of the interior surface of the housing of the electrochemical module; and/or (iii) at least a portion of the exterior surface of the housing of the electrochemical module. In certain embodiments, the inorganic platelet composition is trowelled or sprayed onto a substrate or surface and air dried, with or without heating.

In certain embodiments, the inorganic platelet composition is trowelled, gunned or otherwise applied to the exterior surfaces of the housings of one or more individual battery cells within a battery module and/or larger battery pack, and/or to the surfaces of the battery module or battery pack housing, and/or to structure surrounding the batteries, battery modules or battery packs that would benefit from electrical insulation and fire protection. The inorganic platelet composition may be sprayed, trowelled, dipped, brushed, poured, gunned, molded, injected or otherwise applied to a surface or substrate, and thereafter may remain substantially on the exterior surface of the surface or substrate, penetrate partially or completely into the thickness of the surface or substrate, or both.

In certain embodiments, the inorganic platelet composition is formed into a sheet or blanket and cut to final size. The sheet or blanket can be applied to the exterior surfaces of the housings of one or more individual battery cells within a battery module and/or larger battery pack, and/or to the surfaces of the battery module or battery pack housing, and/or to structure surrounding the batteries, battery modules or battery packs that would benefit from electrical insulation and fire protection.

The inorganic platelet composition may be directly applied to a support layer, for example, without limitation, by roll or reverse roll coating, gravure or reverse gravure coating, transfer coating, spray coating, brush coating, dip coating, tape casting, doctor blading, slot-die coating, deposition coating, dipping, or by immersion. In certain embodiments, the inorganic platelet composition is applied to the support layer as a slurry of the ingredients in a solvent, such as water, and is allowed to dry. The inorganic platelet composition may be created as a single layer or coating on the support layer, thus utilizing a single pass, or may be created by utilizing multiple passes, layers or coatings. By utilizing multiple passes, the potential for formation of defects in the inorganic platelet layer is reduced. If multiple passes are desired, the second and possible subsequent passes may be formed onto the first pass while the first pass is still substantially wet, i.e. prior to drying, such that the first and subsequent passes are able to form a single unitary layer upon drying.

The inorganic platelet composition may further include a flame retardant. The flame retardant material may be selected from any material that delays, inhibits, or slows the spread of fire by suppressing chemical reactions. According to certain embodiments, the flame retardant may comprise antimony compounds, magnesium hydroxide, aluminum hydroxides, aluminum trihydrate, aluminum oxide hydrate, boron compound such as borates, carbonates, bicarbonates, inorganic halides, sulfates, organic halogens, organic phosphorous compounds and combinations thereof. Suitable antimony compounds include, without limitation, antimony trioxide, antimony pentoxide and sodium animonate. Organic halogens include, for example, organobromines and organic chlorines. Suitable organobromines include, without limitation, decabromodiphenyl ether and decabromodiphenyl ethane. Suitable organobromines include polymeric brominated compounds such as brominated polystyrenes, brominated carbonate oligomers, brominated epoxy oligomers, tetrabromophthalic anhydride, tetrabromobisphenol A, and hexabromocyclododecane. Suitable organochlorines include, without limitation, derivatives of chlorenic acid and chlorinated paraffins. Suitable organophosphorus compounds include, without limitation, triphenyl phosphate, resorcinol bis(diphenylphosphate), bisphenol diphenyl phosphate, tricresyl phosphate, triarylphosphates, ammonium polyphosphate, trischloropropyl phosphate, red phosphorous, and phosphonates. Suitable phosphonates include, without limitation, dimethyl methylphosphonate, aluminum diethyl phosphonate, and metal phosphonates.

The inorganic platelet composition and/or a composite or laminate material including the inorganic platelet composition, may include at least one of the following: (i) at least one material that alters the electrical properties of the composition, composite or laminate, such as an electrical insulation composition or material; (ii) a material which alters the heat transfer coefficient of the composition, composite or laminate, such as a material which dissipates heat; (iii) a material which provides moisture resistance to the composition, composite or laminate; (iv) an endothermic material; or (v) any other material which may conventionally be used in thermal/electrical insulation, such as for batteries.

The inorganic platelet composition may be used in an electrochemical battery module or pack. The electrochemical battery module includes a plurality of individual electrochemical battery cells, such as lithium ion cells, that are electrically connected together in series or parallel. Battery modules of electrically connected individual cells may be electrically connected to another battery module to form a battery pack. Each of the individual electrochemical battery cells of the battery module or pack includes an outer housing, an anode, a cathode, a separator separating said anode from said cathode and an electrolyte. According to certain illustrative embodiments, the geometry of outer housing of the battery cell is cylindrical. It is to be noted, however, that there is no limitation to the geometry of the outer housing of the battery cell. The individual battery cells are electrically connected and arranged in close proximity, or in near adjacent contact, to one another to form a module of individual cells. When the individual battery cells are arranged in adjacent or near adjacent contact with one another, there are gaps or open air spaces created between the individual cells resulting from the geometry of the outer housing of the cells. These gaps or open air spaces between the individual cells are referred to in the battery pack art as “interstitial spaces”.

To mitigate the propagation of a thermal runaway event originating in an individual battery or battery module, a barrier comprising an inorganic platelet material is located within at least a portion of the interstitial spaces between said individual battery cells of said lithium ion battery module and/or placed on at least a portion of the interior and/or exterior surfaces of a housing of a battery module or pack. A fluid dispersion or slurry of the inorganic platelet composition may be introduced into the interstitial spaces between the outer surfaces of neighboring battery cells by coating or depositing the inorganic platelet composition onto the outer surfaces of the individual battery cells, and/or injecting the inorganic platelet composition into the interstitial spaces between the individual cells.

Instead of applying the coating to the housing and/or interstitial spaces between the individual cells of the battery module or battery pack in the form of a fluid coating composition, the inorganic platelet composition may be formed into continuous or discontinuous films, papers, or sheets that can be positioned on at least a portion of a surface of a housing of the battery module or pack, and/or in the interstitial spaces between the cells of the module or packs to separate neighboring cells or modules from one another. According to certain embodiments, the outer surface of the adjacent or neighboring battery cells may be wrapped with a suitable amount of the inorganic platelet films and/or sheets. According to other illustrative embodiments, sheets of the inorganic platelets may be positioned in the interstitial spaces between columns or rows of adjacently positioned individual cells. According to yet further illustrative embodiments, a suitable length of continuous films or sheets of inorganic platelet material may be positioned in the interstitial spaces of adjacent battery cells within a single column or row of adjacent cells in a repeated S-shaped pattern.

The battery modules and battery packs comprising a plurality of electrochemical cells may be utilized in an all-electric vehicles (EVs), a plug-in hybrid vehicles (PHEVs), or a hybrid vehicle (HEV). The electric vehicle generally comprises a structural frame, a passenger cabin, an electric drive motor, a motor controller to control the electric drive motor, braking system and electrochemical battery pack for providing power to the drive motor(s). According to certain illustrative embodiments, the battery pack is mounted between the passenger cabin floor panel of an electric vehicle and the driving surface. A thermal insulation barrier comprising an inorganic platelet material is interposed between the battery pack enclosure and the passenger cabin floor panel.

In a first embodiment, the present disclosure is directed to an electrical insulation and fire protection coating composition comprising: inorganic refractory platelets; a binder; a rheology modifier; and a liquid.

The electrical insulation and fire protection coating composition of the first embodiment, wherein the inorganic platelets are selected from the group consisting of vermiculite, mica, clay, talc and combinations thereof

The electrical insulation and fire protection coating composition of any of the first or subsequent embodiments, wherein the inorganic platelets comprise mica platelets.

The electrical insulation and fire protection coating composition of any of the first or subsequent embodiments, wherein the inorganic platelets comprise vermiculite platelets.

The electrical insulation and fire protection coating composition of any of the first or subsequent embodiments, wherein the inorganic platelets comprise clay platelets.

The electrical insulation and fire protection coating composition of any of the first or subsequent embodiments, wherein the inorganic platelets comprise mica platelets having a diameter of from about 20 μm to about 300 μm.

The electrical insulation and fire protection coating composition of any of the first or subsequent embodiments, wherein the inorganic platelets comprise mica platelets having a diameter of from about 40 μm to about 200 μm

The electrical insulation and fire protection coating composition of any of the first or subsequent embodiments, wherein the inorganic platelets comprise mica platelets having an aspect ratio of from about 50:1 to about 2000:1.

The electrical insulation and fire protection coating composition of any of the first or subsequent embodiments, wherein the inorganic platelets comprise mica platelets having an aspect ratio of from about 50:1 to about 1000:1.

The electrical insulation and fire protection coating composition of any of the first or subsequent embodiments, wherein the inorganic platelets comprise mica platelets having an aspect ratio of from about 200:1 to about 800:1.

The electrical insulation and fire protection coating composition of any of the first or subsequent embodiments, wherein the binder is selected from the group consisting of acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, organosilicones, organosilanes, unsaturated polyesters, epoxy resins, polyvinyl esters such as polyvinylacetate or polyvinylbutyrate latexes, and combinations thereof.

The electrical insulation and fire protection coating composition of any of the first or subsequent embodiments, wherein the rheology modifier is selected from the group consisting of acrylates, polyvinyl alcohol, clay, cellulose, substituted cellulose, guar gum, xanthan gum, acacia gum, locust bean gum, agar, pectin, gelatin, carrageenan, sodium alginate, potassium alginate, ammonium alginate, calcium alginate, and combinations thereof.

In a second embodiment, the present disclosure is directed to an electrochemical battery module comprising: a plurality of individual electrochemical battery cells electrically connected together, the electrochemical module comprising interstitial spaces between the individual electrochemical battery cells; and an inorganic platelet composition (i) applied to at least a portion of the exterior surface of at least a portion of the individual electrochemical battery cells contained within a larger bank of electrically connected electrochemical battery cells such as a battery module or battery pack, (ii) applied to at least a portion of the interior surface of the housing of the electrochemical battery pack; (iii) applied to at least a portion of the exterior surface of the housing of the battery pack; and/or (iv) located in at least a portion of the interstitial spaces between a plurality of electrochemical battery cells within a larger battery module or battery pack.

The electrochemical battery module of the second embodiment, wherein the individual electrochemical battery cells comprises lithium ion cells.

The electrochemical battery module of any of the second or subsequent embodiments, wherein the inorganic platelet composition comprises a coating applied to at least a portion of the lithium ion cells in the interstitial spaces between the lithium ion cells.

The electrochemical battery module of any of the second or subsequent embodiments, wherein the inorganic platelet composition comprises a sheet applied to at least a portion of the lithium ion cells in the interstitial spaces between said lithium ion cells.

The electrochemical battery module of any of the second or subsequent embodiments, wherein the inorganic platelet composition sheet comprises a composite comprising a support layer and an inorganic platelet composition layer.

The electrochemical battery module of any of the second or subsequent embodiments, wherein the inorganic platelet composition sheet comprises a composite comprising a support layer and an inorganic platelet composition layer, and wherein the support layer comprises a polymer film, an inorganic fiber paper, a woven fabric or combinations thereof.

The electrochemical battery module of any of the second or subsequent embodiments, wherein the inorganic platelet composition sheet comprises a composite comprising a support layer and an inorganic platelet composition layer, and wherein the support layer comprises a polymer film.

The electrochemical battery module of any of the second or subsequent embodiments, wherein the inorganic platelet composition sheet comprises a composite comprising a support layer and an inorganic platelet composition layer, wherein the support layer comprises a polymer film, and wherein the polymer film is selected from the group consisting of polyester, polyimide, polyetherketone, polyetheretherketone, polyvinylfluoride, polyamide, polytetrafluoroethylene, polyaryl sulfone, polyester amide, polyester imide, polyethersulfone, polyphenylene sulfide, ethylene chlorotrifluoroethylene films and combinations thereof.

The electrochemical battery module of any of the second or subsequent embodiments, wherein the inorganic platelet composition sheet comprises a composite comprising a support layer and an inorganic platelet composition layer, wherein the support layer comprises a polymer film, and wherein the polymer film comprises a polyetheretherketone film.

The electrochemical battery module of any of the second or subsequent embodiments, wherein the inorganic platelet composition sheet comprises a composite comprising a support layer and an inorganic platelet composition layer, wherein the support layer comprises an inorganic fiber paper.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising inorganic fibers selected from the group consisting of polycrystalline wool fibers, refractory ceramic fibers, kaolin fibers, mineral fibers, alkaline earth silicate fibers, calcia-alumina fibers, potassium-alumina-silica fibers, potassium-calcia-alumina fibers, S-glass fibers, S2-glass fibers, E-glass fibers, quartz fibers, silica fibers and combinations of one or more of these types of inorganic fibers.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising refractory ceramic fibers.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising refractory ceramic fibers, wherein the refractory ceramic fibers comprise the fiberization product of about 45 to about 75 weight percent alumina and about 25 to about 55 weight percent silica.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising alkaline earth silicate fibers.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising alkaline earth silicate fibers, wherein the alkaline earth silicate fibers comprise the fiberization product of about 60 to about 90 weight percent silica, from greater than 0 to about 35 weight percent magnesia and 5 weight percent or less impurities.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising alkaline earth silicate fibers, wherein the alkaline earth silicate fibers comprise the fiberization product of about 45 to about 90 weight percent silica, from greater than 0 to about 45 weight percent calcia, from greater than 0 to about 35 weight percent magnesia, and 10 weight percent or less impurities.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising alkaline earth silicate fibers, wherein the alkaline earth silicate fibers comprise the fiberization product of calcia and silica.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprises calcia-alumina fibers.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising calcia-alumina fibers, wherein said calcia-alumina fibers comprise from about 20 to about 80 weight percent calcia and from about 80 to about 20 weight percent alumina.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising silica fibers comprising 90 weight percent or greater silica.

The electrochemical battery module of any of the second or subsequent embodiments, wherein the inorganic platelet composition sheet comprises a composite comprising a support layer and an inorganic platelet composition layer, wherein the support layer comprises an inorganic fiber paper comprising alumina fibers comprising 90 weight percent or greater alumina.

The electrochemical battery module of any of the second or subsequent embodiments, wherein the inorganic platelet composition sheet comprises a composite comprising a support layer and an inorganic platelet composition layer, wherein the support layer comprises a woven fabric.

In a third embodiment, the present disclosure is directed to a lithium ion battery module comprising: a plurality of individual lithium ion cells electrically connected together, each of said lithium ion cells comprising an outer housing, an anode, a cathode, a separator separating said anode from said cathode and an electrolyte, said lithium ion battery module comprising interstitial spaces between the individual lithium ion cells; and an inorganic platelet composition (i) applied to at least a portion of the exterior surfaces of at least a portion of the individual electrochemical battery cells contained within a larger bank of electrically connected electrochemical battery cells such as a battery module or battery pack, (ii) applied to at least a portion of the interior surface of the housing of the electrochemical battery pack; (iii) applied to at least a portion of the exterior surfaces of the housing of the battery pack; and/or (iv) applied to at least a portion of the interstitial spaces between a plurality of electrochemical battery cells within a larger battery module or battery pack.

In a fourth embodiment, the present disclosure is directed to a lithium ion battery pack comprising: a plurality of individual lithium ion cells electrically connected together, each of said lithium ion cells comprising an outer housing, an anode, a cathode, a separator separating said anode from said cathode and an electrolyte said lithium ion battery module comprising interstitial spaces between the individual lithium ion cells; and an inorganic platelet composition located (i) applied to at least a portion of the exterior surfaces of at least a portion of the individual electrochemical battery cells contained within a larger bank of electrically connected electrochemical battery cells such as a battery module or battery pack, (ii) applied to at least a portion of the interior surface of the housing of the electrochemical battery pack; (iii) applied to at least a portion of the exterior surfaces of the housing of the battery pack; and/or (iv) applied to at least a portion of the interstitial spaces between a plurality of electrochemical battery cells within a larger battery module or battery pack.

In a fifth embodiment, the present disclosure is directed to an automobile battery comprising: a plurality of individual lithium ion cells electrically connected together, each of said lithium ion cells comprising an outer housing, an anode, a cathode, a separator separating said anode from said cathode and an electrolyte, said lithium ion battery module comprising interstitial spaces between the individual lithium ion cells; and an inorganic platelet composition located (i) applied to at least a portion of the exterior surfaces of at least a portion of the individual electrochemical battery cells contained within a larger bank of electrically connected electrochemical battery cells such as a battery module or battery pack, (ii) applied to at least a portion of the interior surface of the housing of the electrochemical battery pack; (iii) applied to at least a portion of the exterior surfaces of the housing of the battery pack; and/or (iv) applied to at least a portion of the interstitial spaces between a plurality of electrochemical battery cells within a larger battery module or battery pack.

In a sixth embodiment, the present disclosure is directed to an electric vehicle comprising: a structural frame; a passenger cabin; an electric drive motor; a motor controller; braking system; and electrochemical battery pack mounted below said passenger cabin, said electrochemical battery pack comprising a plurality of individual battery cells electrically connected together and having interstitial spaces between the individual battery cells, an inorganic platelet composition located (i) applied to at least a portion of the exterior surfaces of at least a portion of the individual electrochemical battery cells contained within a larger bank of electrically connected electrochemical battery cells such as a battery module or battery pack, (ii) applied to at least a portion of the interior surface of the housing of the electrochemical battery pack; (iii) applied to at least a portion of the exterior surfaces of the housing of the battery pack; and/or (iv) applied to at least a portion of the interstitial spaces between a plurality of electrochemical battery cells within a larger battery module or battery pack.

In a seventh embodiment, the present disclosure is directed to an aircraft battery comprising: a plurality of individual lithium ion cells electrically connected together, each of said lithium ion cells comprising an outer housing, an anode, a cathode, a separator separating said anode from said cathode and an electrolyte, said lithium ion battery module comprising interstitial spaces between the individual lithium ion cells; and an inorganic platelet composition located (i) applied to at least a portion of the exterior surfaces of at least a portion of the individual electrochemical battery cells contained within a larger bank of electrically connected electrochemical battery cells such as a battery module or battery pack, (ii) applied to at least a portion of the interior surface of the housing of the electrochemical battery pack; (iii) applied to at least a portion of the exterior surfaces of the housing of the battery pack; and/or (iv) applied to at least a portion of the interstitial spaces between a plurality of electrochemical battery cells within a larger battery module or battery pack.

An automobile battery comprising at least one electrochemical battery module according to any of the second or subsequent embodiments.

An electric vehicle comprising: a structural frame; a passenger cabin; an electric drive motor; a motor controller; braking system; and a battery comprising at least one electrochemical battery module according to any of the second or subsequent embodiments.

An aircraft battery comprising at least one electrochemical battery module according to any of the second or subsequent embodiments.

While the electrical insulation and fire protection coating composition and electrochemical battery module and packs including the same have been described in connection with various embodiments, it is to be understood that other similar embodiments may be used or modifications and additions may be made to the described embodiments for performing the same function. Furthermore, the various illustrative embodiments may be combined to produce the desired results. The disclosure should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. An electrical insulation and fire protection coating composition comprising:
inorganic refractory platelets;
a binder;
a rheology modifier; and
a liquid.

2. The electrical insulation and fire protection coating composition of claim 1, wherein said inorganic platelets are selected from the group consisting of vermiculite, mica, clay, talc and combinations thereof.

3. The electrical insulation and fire protection coating composition of claim 2, wherein said inorganic platelets comprise mica platelets.

4. The electrical insulation and fire protection coating composition of claim 2, wherein said inorganic platelets comprise vermiculite platelets.

5. The electrical insulation and fire protection coating composition of claim 2, wherein said inorganic platelets comprise clay platelets.

6. The electrical insulation and fire protection coating composition of claim 3, wherein said mica platelets have a diameter of from about 20 μm to about 300 μm.

7. The electrical insulation and fire protection coating composition of claim 3, wherein said mica platelets have an aspect ratio of from about 50:1 to about 2000:1.

8. The electrical insulation and fire protection coating composition of claim 7, wherein said mica platelets have an aspect ratio of from about 50:1 to about 1000:1.

9. The electrical insulation and fire protection coating composition of claim 1, wherein said binder is selected from the group consisting of acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, organosilicones, organosilanes, unsaturated polyesters, epoxy resins, polyvinyl esters and combinations thereof.

10. The electrical insulation and fire protection coating composition of claim 1, wherein said rheology modifier is selected from the group consisting of acrylates, polyvinyl alcohol, clay, cellulose, substituted cellulose, guar gum, xanthan gum, acacia gum, locust bean gum, agar, pectin, gelatin, carrageenan, sodium alginate, potassium alginate, ammonium alginate, and calcium alginate and combinations thereof

11. An electrochemical battery module comprising:
a plurality of individual electrochemical battery cells electrically connected together within a housing, said electrochemical module comprising interstitial spaces between the individual electrochemical battery cells; and
an inorganic platelet composition (i) applied to at least a portion of the exterior surface of the individual electrochemical battery cells, (ii) applied to at least a portion of the interior surface of the housing of the electrochemical module; (iii) applied to at least a portion of the exterior surface of the housing of the electrochemical module; and/or (iv) located within at least a portion of the interstitial spaces between the plurality of electrochemical battery cells.

12. The electrochemical battery module of claim 11, wherein said inorganic platelet composition comprises a coating.

13. The electrochemical battery module of claim 11, wherein said inorganic platelet composition comprises a sheet.

14. The electrochemical battery module of claim 11, wherein said inorganic platelet composition comprises a composite comprising a support layer and an inorganic platelet composition layer.

15. The electrochemical battery module of claim 14, wherein said support layer comprises a polymer film, an inorganic fiber paper, a woven fabric or combinations thereof.

16. The electrochemical battery module of claim 15, wherein said support layer comprises a polymer film.

17. The electrochemical battery module of claim 16, wherein said polymer film is selected from the group consisting of polyester, polyimide, polyetherketone, polyetheretherketone, polyvinylfluoride, polyamide, polytetrafluoroethylene, polyaryl sulfone, polyester amide, polyester imide, polyethersulfone, polyphenylene sulfide, ethylene chlorotrifluoroethylene films and combinations thereof.

18. The electrochemical battery module of claim 17, wherein said support layer comprises an inorganic fiber paper.

19. The electrochemical battery module of claim 18, wherein said inorganic fiber paper comprises inorganic fibers selected from the group consisting of polycrystalline wool fibers, refractory ceramic fibers, kaolin fibers, mineral fibers, alkaline earth silicate fibers, calcia-alumina fibers, potassium-alumina-silica fibers, potassium-calcia-alumina fibers, S-glass fibers, S2-glass fibers, E-glass fibers, quartz fibers, silica fibers and combinations thereof.

20. The electrochemical battery module of claim 19, wherein said refractory ceramic fibers comprise the fiberization product of about 45 to about 75 weight percent alumina and about 25 to about 55 weight percent silica.

21. The electrochemical battery module of claim 19, wherein said inorganic fibers comprise alkaline earth silicate fibers.

22. The electrochemical battery module of claim 21, wherein said alkaline earth silicate fibers comprise the fiberization product of about 60 to about 90 weight percent silica, from greater than 0 to about 35 weight percent magnesia.

23. The electrochemical battery module of claim 15, wherein said support layer comprises a woven fabric.

24. A lithium ion battery module for an automobile or aircraft comprising:
a plurality of individual lithium ion cells electrically connected together within a housing, each of said lithium ion cells comprising an outer housing, an anode, a cathode, a separator separating said anode from said cathode and an electrolyte, said lithium ion battery module comprising interstitial spaces between the individual lithium ion cells; and
an inorganic platelet composition (i) applied to at least a portion of the exterior surface of the individual lithium ion cells, (ii) applied to at least a portion of the interior surface of the housing of the lithium ion battery module; (iii) applied to at least a portion of the exterior surface of the housing of the lithium ion battery module; and/or (iv) located within at least a portion of the interstitial spaces between the plurality of individual lithium ion cells.
